(19) United States
(12) Patent Application Publication
(10) Pub. No.: US 2022/0311289 A1
(43) Pub. Date: Sep. 29, 2022

(54) MACHINE WITH TOROIDAL WINDING

(71) Applicant: Moving Magnet Technologies, Besançon (FR)

(72) Inventors: Stéphane Tavernier, Chemaudin et Vaux (FR); Gaël Andrieux, Evilard (CH)

(21) Appl. No.: 17/753,354

(22) PCT Filed: Aug. 26, 2020
(86) PCT No.: PCT/FR2020/051501

§ 371 Date: Feb. 28, 2022

(30) Foreign Application Priority Data
Aug. 27, 2019 (FR) 1909432

(51) Int. Cl. H02K 1/14; H02K 1/18; H02K 9/22; H02K 21/16

(52) U.S. Cl. CPC H02K 1/148; H02K 1/185; H02K 9/22; H02K 21/16; H02K 2213/03

(57) ABSTRACT

An electric machine comprises a yoke supporting N toroidal coils and a central rotor comprising a permanent magnet. The yoke has a plurality of stator modules comprising at least one stator core made from a soft ferromagnetic material supporting at least one coil. The stator cores have, at their front ends, complementary coupling surfaces providing magnetic and mechanical continuity. The machine further comprises—a cylindrical outer casing made from a thermally conductive material, —a plurality of continuous and solid longitudinal ribs extending radially and positioned between the cylindrical outer casing and the stator modules, in order to ensure the mechanical positioning of the yoke relative to the outer casing and promote the thermal conduction of heat from the yoke toward the outer casing.

### CROSS-REFERENCE TO RELATED APPLICATIONS

This application is a national phase entry under 35 U.S.C. § 371 of International Patent Application PCT/FR2020/051501, filed Aug. 26, 2020, designating the United States of America and published as International Patent Publication WO 2021/038168 A1 on Mar. 4, 2021, which claims the benefit under Article 8 of the Patent Cooperation Treaty to French Patent Application Serial No. 1909432, filed Aug. 27, 2019.

### TECHNICAL FIELD

The present disclosure relates to the field of brushless permanent magnet electric machines consisting of a yoke consisting of modules forming a structure of polygonal or circular cross-section and receiving toroidal coils surrounding the arms of this structure.

### BACKGROUND

A rotor comprising a diametral cylindrical magnet interacts with the rotating magnetic field produced by the electric coils. This type of electric machine differs from other notched machines having a wound yoke creating field lines between pole teeth. These toroidal structures are particularly favorable for motors rotating at high speed, due to minimizing the residual torque (without current) and the various iron losses at the stator and at the rotor due to the absence of teeth near the rotating magnet and to a larger magnetic air gap.

Known in the state of the art is United States Patent Application Publication No. US2012128512, which describes a high-speed polyphase motor for a turbocharger, comprising a stator and a rotor. The rotor is equipped with a turbine. The stator comprises a ferromagnetic core and a winding, the winding being constructed as a series of coils that are toroidally wound around the stator core and that are physically separated to form an open space. A shell is constructed so as to create an additional open space between the stator core and the shell, this open space being composed of a cooling channel confined inside by the rotor and the stator core.

Also known is European Patent Application EP0754365, which describes an electric motor, comprising:
a bore seal tube;
a single rotor comprising a pair of identical coaxial cylindrical bipolar permanent magnet sections positioned within the bore seal tube;
a non-magnetic retaining hoop positioned within the bore seal tube;
a pair of non-magnetic stub shafts positioned within the bore seal tube and supported by the non-magnetic retaining hoop, each of the non-magnetic stub shafts being positioned on one end of a corresponding permanent magnet section of the pair of the sections;
a non-magnetic separator positioned within the bore seal tube to separate and axially position the pair of permanent magnet sections;

the non-magnetic retaining hoop surrounding and retaining the permanent magnet sections, the stub shafts and the non-magnetic separator;
a pair of stators, each of which is positioned outside the bore seal tube in operative relationship with a corresponding magnetized section of the pair of the sections;
a retainer surrounding the pair of stators; and
the retainer and the bore seal tube cooperating to retain the pair of stators in operative relationship with corresponding magnetized sections of the single rotor, the magnetized sections and the corresponding stators thereby being retained in tandem to provide the redundant electric motor configuration.

U.S. Patent Application Publication No. US2018175706 describes a stator assembly that is used to be assembled to form a stator core. The stator assembly comprises a tooth and a yoke. One end of the tooth is connected to the yoke. The yoke has an inner side, an outer side, a first coupling side and a second coupling side. The first coupling side further comprises a first engagement structure, and the second coupling side further comprises a second engagement structure. The second engagement structure corresponds to the first engagement structure. The outer side has a groove. The groove has a side surface and a bottom surface. An angle is defined between the side surface and the bottom surface, and the angle is in a range of 135° to 165°.

Japanese Patent Application JPS5970154 describes another example of a motor that may be assembled and disassembled simply by winding a toroidal winding on a stator core after mounting a non-magnetic spacer ring on the core. The two parts of the split core are formed with insulating layers on the inner periphery of a slot and on both the upper and lower end surfaces. Spacer rings split similarly to the split portions of the core are respectively mounted on the outer radius surfaces of the cores. After the rings are mounted, a toroidal winding is formed on a yoke for each slot at all of the cores. After the winding is completed, the split cores are glued into a circular shape, and a steel plate frame is mounted on the outer periphery of the protrusion of the rings to complete a stator.

U.S. Patent Application Publication No. US2002089242 describes an electric machine that comprises a stator core having first and second ends and having windings therein, with end turns of the windings projecting from the first and second ends of the stator core. A rotor is rotatably positioned within the stator core. First and second sets of laminated aluminum rings are positioned against the first and second ends, respectively, of the stator core in contact with the housing. A thermally conductive potting material is positioned between the end turns and the respective first and second ring assemblies at the first and second ends of the stator core, thereby creating heat dissipation paths from the end turns, through the potting material and the ring assemblies to the housing.

The solutions of the prior art nevertheless present sources of noise pollution by the magnetic noise produced at the joints of the yoke, for example, by the forced circulation of a fluid between thin strips of material. The heat dissipation is furthermore far from sufficient when the machine must provide a power of several kilowatts in a small diameter (typically less than 100 mm), due to the fact that the electrical conductors have a small exchange surface with the outside medium (housing or flange). Furthermore, the manufacture and assembly of electric machines according to the state of the art are relatively complex, in particular, their integration into the external environment.

In the solution proposed by U.S. Patent Application Publication No. US2012128512, in particular, the heat of the wound stator is discharged by fins dissipating the heat in a tubular cooling space, by convection in the air, which does not allow sufficient efficiency to be ensured, or requires the circulation of an air flow in this tubular space.

### BRIEF SUMMARY

The present disclosure aims to address these drawbacks. To this end, it concerns, in its most general sense, an electric machine comprising a yoke supporting N toroidal coils, and a central rotor comprising a permanent magnet,
the yoke including a plurality of stator modules having at least one core made from a soft ferromagnetic material supporting at least one coil,
wherein
the stator modules have, at the front ends of the cores, complementary coupling surfaces providing magnetic and mechanical continuity,
   the machine further comprises: a cylindrical outer casing made from a thermally conductive material,
   a plurality of continuous and solid longitudinal ribs extending radially and positioned between the cylindrical outer casing and the stator modules, in order to ensure the mechanical positioning of the yoke relative to the cylindrical outer casing and to promote thermal conduction of the heat from the stator modules toward the cylindrical outer casing.

Within the meaning of the present disclosure, “continuous and solid longitudinal ribs” means a protruding part, forming a block of material or a package of rolled sheets forming a block with no empty space.

In one embodiment,
the yoke consists of N/2 stator modules having two stator cores made from a soft ferromagnetic material, called arms,
the two arms extending symmetrically with respect to a radial median plane,
each of the arms supporting a coil,
the arms having, at their front ends, complementary assembly zones providing magnetic continuity.

Alternatively, the stator modules have two stator cores made from a soft ferromagnetic material extending on either side of a continuous and solid rib directed toward the side opposite the rotor and coming into contact with the inner surface of the cylindrical outer casing made from a thermally conductive material.

The cylindrical outer casing may then be made from a thermally conductive material having radially extending ribs, the front end of which comes into contact with the stator cores made from a soft ferromagnetic material, at the intersection of two adjacent arms.

In general, the multiple longitudinal connections, or longitudinal ribs, providing thermal conduction between the yoke and the cylindrical outer casing, are continuous and solid. “Continuous and solid” means that these connections are not made up of multiple strips of material separated by air knives, but have a continuity of material so as to promote thermal conductivity between the yoke supporting the coils and the outer casing. By way of example, these longitudinal connections may be made from a one-piece material, from an assembly of several one-piece elements, or from a stack of sheets. These examples are not, however, limiting with respect to the present disclosure, and any design that a person skilled in the art would consider to promote the drainage of heat from the yoke via the longitudinal connections so as to discharge it toward the outer casing is envisaged. Conversely, a design aiming to discharge the heat directly via the longitudinal connections, by conduction with a fluid or natural or forced convection, is not a desired effect. Thus, if the longitudinal connection is made up of multiple radial elements slightly separated by an air gap, this does not confer an advantage for the discharge of heat with respect to the claimed effect.

Optionally, the ribs and/or the front ends have a chamfer to allow the forcible introduction of the yoke into the cylindrical outer casing and/or are in contact with the lateral ends of two consecutive stator modules to ensure the positioning of the stator modules constituting the yoke.

In an alternative embodiment, the yoke is made up of N stator modules each having a stator core made from a soft ferromagnetic material supporting a coil whose turns are arranged in planes forming an increasing angle on either side of the median transverse plane of the coil,
the stator cores having, at their front ends, complementary assembly zones providing magnetic continuity,
the machine further comprising a cylindrical outer casing having N longitudinal ribs, the inner front surface of which comes into contact with the outer surface of the connection zone of two adjacent stator cores, in order to ensure the mechanical wedging of the yoke with respect to the outer casing and thermal conduction of the heat from the yoke to the cylindrical outer casing.

In another embodiment, a stack of sheets in the axial direction and made from a non-magnetic material, but which is a better thermal conductor than air, is positioned at the interface between the casing and the coil, the stack of sheets preferentially being in contact with the outer casing and the coil.

In a variant, a thermally conductive material is arranged at the interface between the outer casing and the coil, the thermally conductive material preferentially being in contact with the outer casing and the coil.

### BRIEF DESCRIPTION OF THE DRAWINGS

The present disclosure will be better understood on reading the detailed description of a non-limiting example of the present disclosure, which follows, with reference to the accompanying drawings, where:

FIG. 1 shows a cross-sectional view of a first embodiment,

FIG. 2 shows a cross-sectional view of a first variant embodiment,

FIG. 3 shows a cross-sectional view of a second variant embodiment,

FIG. 4 shows a cross-sectional view of a third variant embodiment,

FIG. 5 shows a cross-sectional view of a fourth variant embodiment,

FIG. 6 shows a cross-sectional view of a fifth variant embodiment.

FIG. 7 shows a cross-sectional view of a sixth variant embodiment.

### DETAILED DESCRIPTION

The present disclosure relates to a configuration of a stator comprising a yoke formed by several modules, all identical. Each stator module has at least one stator core (218) extending perpendicular to a radius passing through the middle of this stator core (218), and which is surrounded by a coil (211).

This stator core (218) is mechanically and thermally coupled to a cylindrical outer casing (200) surrounding the stator via continuous and solid longitudinal connections, of rectangular cross-section, extending over the entire length of the stator between:
a) the inner surface of the cylindrical outer casing (200), and
b) the junction zone of two stator cores (218, 226).

These longitudinal connections provide a dual function:
mechanical wedging of the stator modules with respect to the cylindrical outer casing (200)
thermal transmission of the heat produced by the coils (211) to the cylindrical outer casing (200). The longitudinal connections are therefore continuous and solid, possibly laminated, so as to maximize the thermal conductivity between the yoke of the stator and the cylindrical outer casing (200). The cylindrical outer casing (200) is then itself associated with a cooled housing, with fins, or directly ensures the discharge of heat to the outside of the motor.

To this end, the connection between the stator modules and the cylindrical outer casing (200) is made either by continuity of the material, or by a tight fit ensuring direct contact with the ferromagnetic material.

The following description illustrates different implementation alternatives based on this general principle, where:
the stator modules are formed by a core surrounded by its coil, the longitudinal connections then being monolithic ribs extending the inner surface of the cylindrical outer casing (200), these ribs having a longitudinal groove in which the outer edges fit two consecutive stator cores (218, 226), without play,

or
the stator modules have a “Y”-shaped cross-section, the foot then forming the longitudinal connection, the front surface of which bears tightly against the inner surface of the cylindrical outer casing (200), and the two arms constituting two stator cores (216, 218) each supporting a coil, the longitudinal front surfaces of the arms of two adjacent stator modules coming into close contact,

or
the modules have a “U”-shaped cross-section, the two branches of the “U” then forming the continuous and solid longitudinal connection, the front surface of which bears tightly against the inner surface of the cylindrical outer casing (200), and the zone connecting the two branches of the “U” constituting the core (218) supporting a coil, the longitudinal front surfaces of the arms of two adjacent stator modules coming into close contact,

or
a mix of these two solutions, alternately with a “Y” configuration and a rib formed on the cylindrical outer casing (200)

and more generally any configuration ensuring:
a) continuity or assembly without play and with ferromagnetic, thermal and mechanical continuity between the longitudinal front ends of the cores (218);
b) continuity or assembly without play and with thermal and mechanical continuity between the longitudinal front junction zones of two consecutive stator cores (218, 226) and the cylindrical outer casing (200).

The assembly being able to be assembled by longitudinal sliding of the stator modules provided with the coils (211, 261, 227, 231, 241, 251) in the cylindrical outer casing (200), with an assembly without play after positioning of the modules.

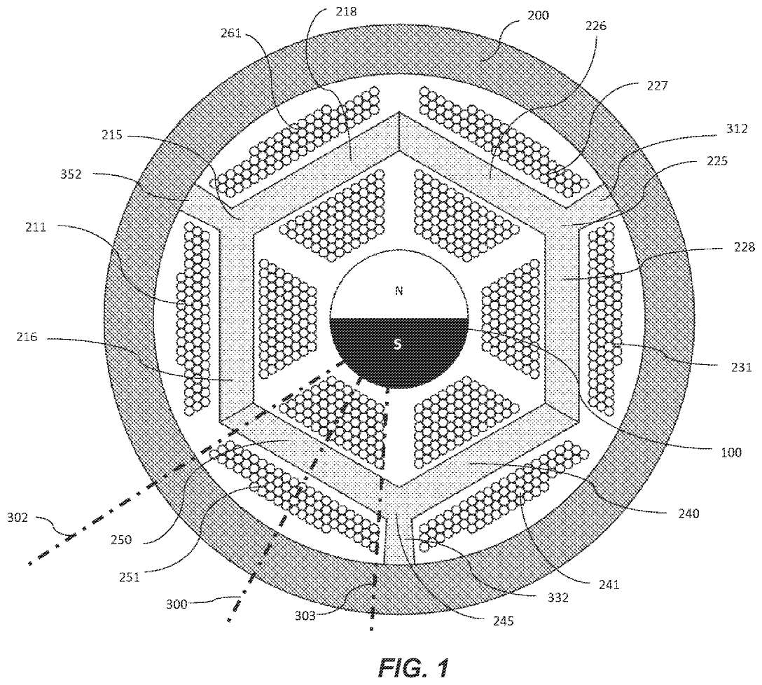

FIG. 1 shows a cross-sectional view of a first embodiment.

The electric machine comprises a rotor (100) with a diametrically magnetized tubular magnet, covered with a hoop (not visible) to prevent the pulling out of particles under the effect of the centrifugal force for high-speed machines.

It comprises a metallic cylindrical outer casing (200), manufactured, for example, by molding, foundry or even by profiling, surrounding a stator comprising toroidal coils (211, 261; 227, 231; 241, 251) and a yoke in the form of a set of three longitudinal stator modules (215, 225, 245), having a “Y”-shaped section, with a rib extending on either side of two stator cores, respectively (216, 218; 226, 228; 240, 250), these stator cores being made from a soft ferromagnetic material, preferably a stack of sheets. Each of the stator cores (216, 218, 226, 228, 240, 250) is surrounded by a coil, respectively (211, 261; 227, 231; 241, 251).

The coils (211, 261, 227, 231, 241, 251) are formed with turns of an electrically conductive material—copper or aluminum, for example, whose inclination varies. The plane (302) formed by the turn at the start of the winding forms an open angle with the radial plane (300). This angle is reduced to become zero for the median turns whose plane coincides with the radial plane (300), then this angle between the plane of the turn and the radial plane (300) increases again—in the opposite direction—up to the end of the winding, where the angle of the turn (303) again has an open angle with respect to the radial plane (300). Furthermore, the section of the winding is not identical inside and outside the stator, on either side of the stator cores (216, 218; 226, 228; 240, 250). Indeed, to optimize the overall volume of the machine, but also to optimize the performance of the motor, the turns outside the stator cores (216, 218; 226, 228; 240, 250) are distributed over the entire length of the formed polygonal side. This configuration allows the copper volume of the winding to be maximized while limiting the outer diameter and the volume of the machine.

The wedging of the stator modules with respect to the cylindrical outer casing (200) is ensured, in this embodiment, by the external shape of the front surface of the longitudinal ribs (312, 332, 352) forming the foot of the “Y” in cross-section, which come into contact with the cylindrical outer casing (200). The cylindrical outer casing (200) is generally made of a material having good thermal conduction properties, for example, aluminum, which also allows the stator modules (215, 225, 245) to conduct the heat flux produced by the coils (211, 261, 227, 231, 241, 251) during machine operation.

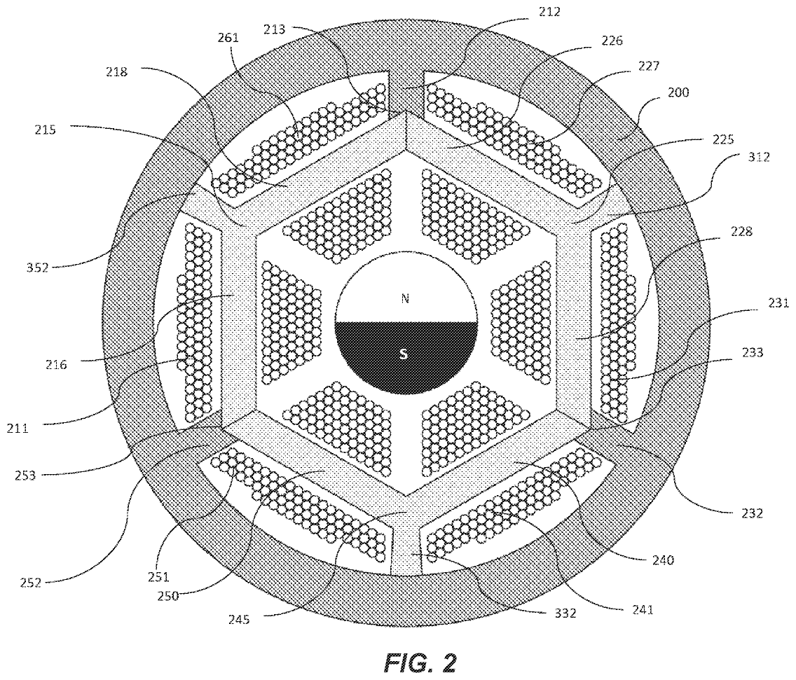

In the embodiment illustrated in FIG. 2, the wedging of the stator modules with respect to the cylindrical outer casing (200) is ensured firstly by longitudinal ribs (212, 232, 252) extending the inner surface of the cylindrical outer casing (200), and having an inner border configured to receive the outer surface of the connection zone of two adjacent stator modules.

To this end, the longitudinal ribs (212, 232, 252) have a “V”-shaped groove (213, 233, 253) in which the edge formed by two adjacent stator cores (216, 250; 218, 226; 228, 240) is able to slide longitudinally during assembly, and to ensure the wedging after installation inside the cylindrical outer casing (200).

Wedging is also ensured by the outer longitudinal surface of the three stator modules (215, 225, 245), having a rounded contact surface, with a radius of curvature corresponding to the radius of curvature of the inner surface of the cylindrical outer casing (200).

The contact between the three stator modules (215, 225, 245) and the cylindrical outer casing (200) and between the longitudinal ribs (212, 232, 252) and the edges of the stator cores (218, 226, 228, 240, 250, 216) provides mechanical wedging and thermal conduction bridges allowing discharging of the heat produced by the electric coils (211, 261, 227, 231, 241, 251) of the machine.

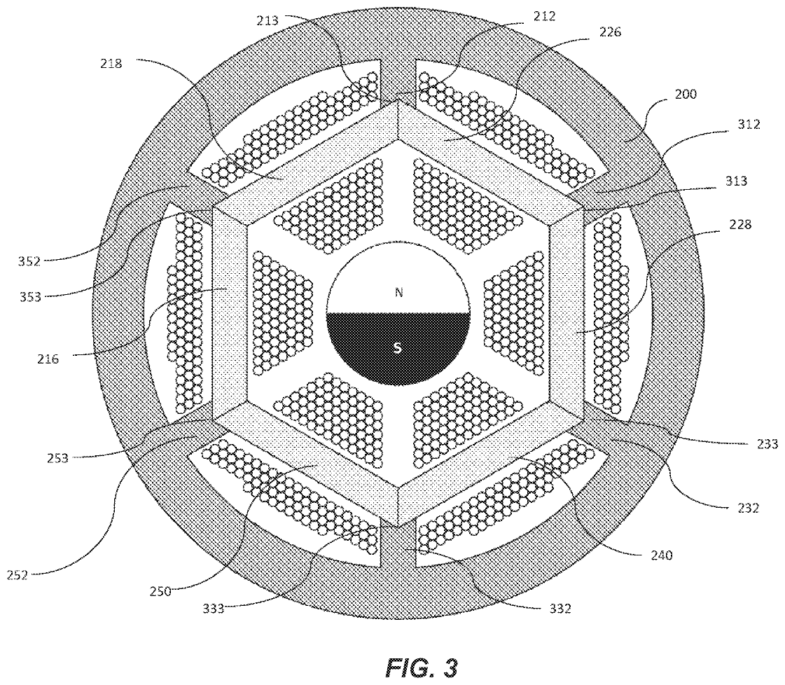

FIG. 3 shows a cross-sectional view of an embodiment that differs from the previous ones in that it only comprises longitudinal ribs (212, 312, 232, 332, 252, 352) radially extending the cylindrical outer casing (200), as wedging elements and thermal contact between the cylindrical outer casing (200) and the stator cores (218, 226, 228, 240, 250, 216) that do not have ribs.

The ends of the ribs (212, 312, 232, 332, 252, 352) advantageously have a chamfer to facilitate relative positioning at the time of assembly.

In particular, these ribs (212, 312, 232, 332, 252, 352) have “V”-shaped grooves (213, 313, 233, 333, 253, 353) to ensure the wedging of the connection zones of two adjacent stator cores.

The yoke of the stator may be inserted by axial sliding in the cylindrical outer casing (200), the connection zones of the stator cores (216, 218, 226, 228, 240, 250) sliding in the “V”-shaped grooves (213, 313, 233, 333, 253, 353) of the longitudinal ribs (212, 312, 232, 332, 252, 352).

Thermal transmission is ensured by these radial elements, which also ensure the mechanical wedging of the yoke with respect to the cylindrical outer casing (200).

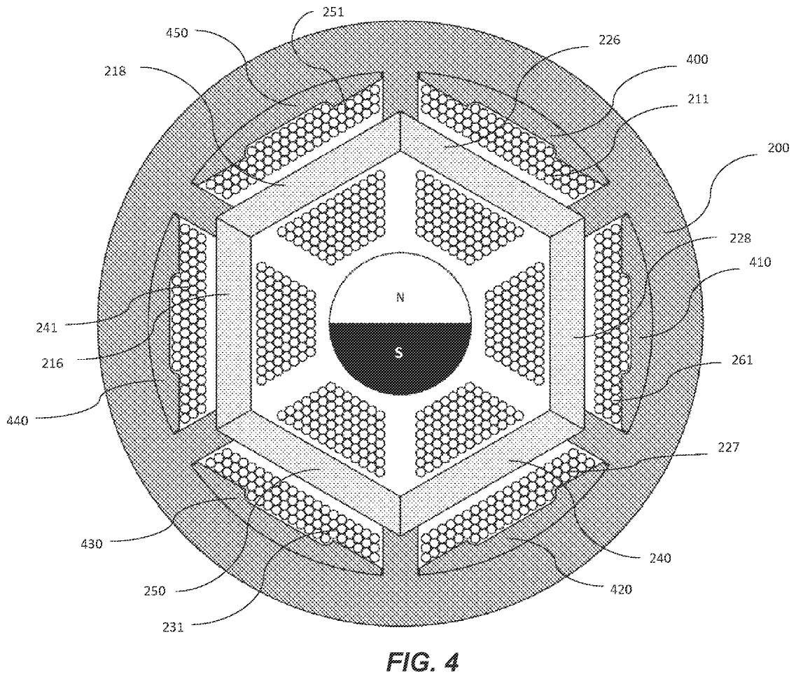

FIGS. 4 to 6 show variant embodiments with the aim of improving the heat dissipation performance of the machine toward the cylindrical outer casing (200). To do this, it is proposed to fill the free space between the machine and the cylindrical outer casing (200) with a thermally conductive but non-magnetic material minimizing the development of induced currents during operation of the machine. In the present example, a stack of aluminum sheets (400, 410, 420, 430, 440, 450, 401) is proposed. Thermal conduction is thus maximized without disturbing the operation of the machine, since stacking the sheets (400, 410, 420, 430, 440, 450, 401) in the axial direction, a direction perpendicular to the majority of the magnetic field lines of the motor, will limit the development of induced currents and therefore losses.

The shape of these stacks of sheets (400, 410, 420, 430, 440, 450, 401) may vary. In the first example of FIG. 4, the shape hugs the coils (211, 261, 227, 231, 241, 251) and the stator cores (216, 218, 226, 228, 240, 250) as closely as possible. These stacks of sheets (400, 410, 420, 430, 440, 450) have an arcuate blade shape to allow them to be housed between two consecutive ribs, against the inner surface of the cylindrical outer casing (200). The stack of sheets (400) is as close as possible to the coils, the source of the heat dissipation.

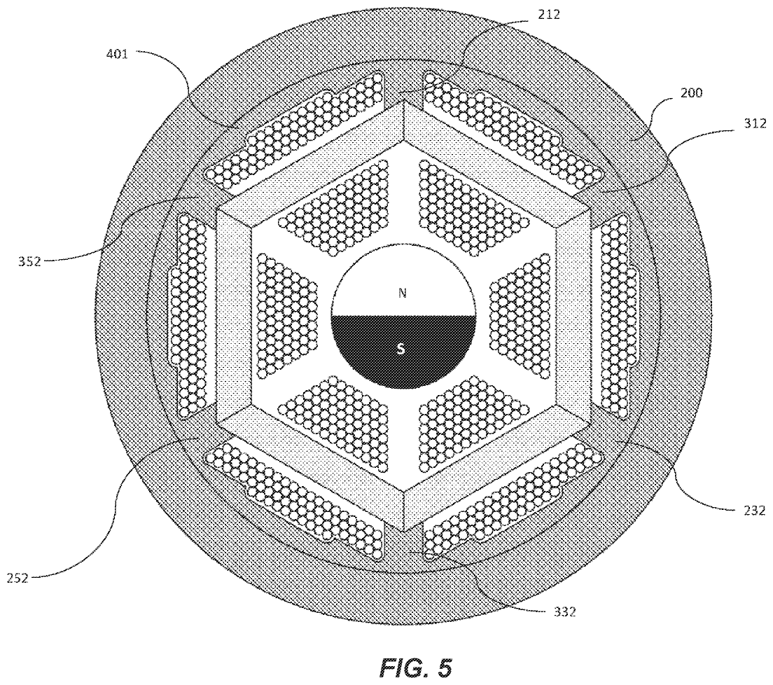

In a second example in FIG. 5, the stack of sheets (401) forms a ring that is housed coaxially inside the cylindrical outer casing (200). This ring of sheets has ribs (212, 312, 232, 332, 252, 352) ensuring the mechanical wedging of the stator and the transmission of heat between the yoke of the stator supporting the coils and the cylindrical outer casing (200).

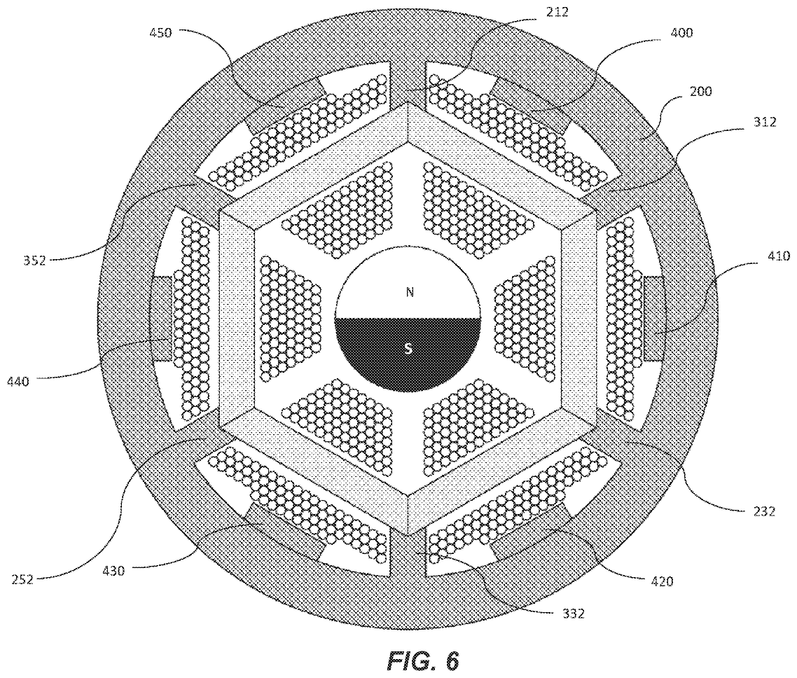

In a third example in FIG. 6, the stack of sheets (400, 410, 420, 430, 440, 450) takes the form of longitudinal blades inserted locally between the cylindrical outer casing (200) and the coils. The ribs (212, 312, 232, 332, 252, 352) are, as in the case of the example of FIG. 3, interior extensions of the cylindrical outer casing (200).

These examples are not limiting, and other variants may be proposed without departing from the present disclosure.

Indeed, the present disclosure is not limited to the use of aluminum sheets. The stack of sheets may be made from another material, benefiting from better thermal conductive properties than air. Similarly, any solid material may be used as long as it is a better thermal conductor than air and is non-magnetic and electrically insulating, or has poor magnetic and electrical properties relative to iron.

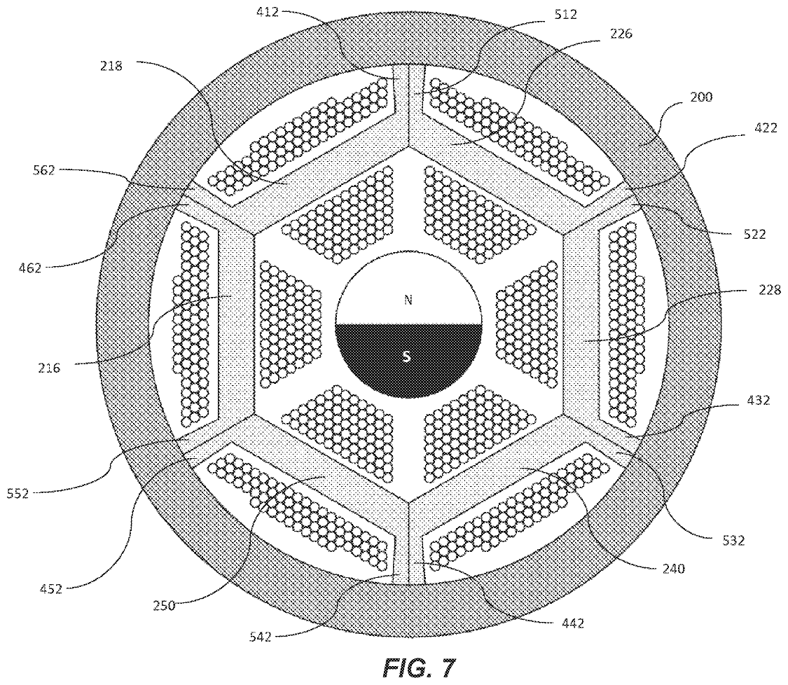

FIG. 7 shows a cross-sectional view of an embodiment that differs from the previous ones in that the stator cores (218, 226, 228, 240, 250, 216) are extended at each end by an extension (412, 562; 422, 512; 432, 522, 442, 532; 452, 542; 462, 552) giving the stator cores a “U” shape. Pairs of the extensions (412, 512; 422, 522; 432, 532, 442, 542; 452, 552; 462, 562) of two separate stator cores are assembled to form the longitudinal ribs as wedging elements and thermal contact between the cylindrical outer casing (200) and the various stator cores (218, 226, 228, 240, 250, 216).

The yoke of the stator may be inserted by axial sliding in the casing, the ribs having, at their radial ends, shapes complementary to the cylindrical outer casing (200).

The extensions (412, 422, 432, 442, 452, 462) and (512, 522, 532, 542, 552, 562) have complementary shapes, such as, for example, a dovetail, cooperating by axial sliding to secure two adjacent stator cores.

1. An electric machine, comprising:
a yoke supporting N toroidal coils, the yoke having a plurality of stator modules each having at least one core comprising a soft ferromagnetic material supporting at least one coil of the N toroidal coils, the stator module having, at front ends of the cores, complementary coupling surfaces providing magnetic and mechanical continuity;
a central rotor comprising a permanent magnet;
a cylindrical outer casing made from a thermally conductive material; and
a plurality of continuous and solid longitudinal ribs extending radially and positioned between the cylindrical outer casing and the stator modules to ensure the mechanical positioning of the yoke relative to the cylindrical outer casing and promote thermal conduction of heat from the stator modules toward the cylindrical outer casing.

2. The electric machine of claim 1, wherein the longitudinal ribs radially extend either the cylindrical outer casing or one of the stator modules made from a soft ferromagnetic material, or are in the form of a conductive material placed at the interface between the cylindrical outer casing and the stator modules.

3. The electric machine of claim 2, each coil is in the form of wound turns arranged in planes forming, with a radial plane, an increasing angle on either side of a median transverse plane of the coil, so that the radial thickness of the coil is greater inside than outside of the yoke.

4. The electric machine of claim 3, wherein:
the yoke is made up of N/2 stator modules made from a soft ferromagnetic material having two stator cores defining arms;
the two arms extending symmetrically with respect to a radial median plane;
each of the arms supporting a coil; and
the arms having, at their front ends, complementary assembly zones providing magnetic continuity.

5. The electric machine of claim 4, wherein the stator modules made from a soft ferromagnetic material have two stator cores extending on either side of a rib directed toward the side opposite the rotor and coming into contact with the inner surface of the cylindrical outer casing made from a thermally conductive material.

6. The electric machine of claim 4, wherein the cylindrical outer casing made from a thermally conductive material has radially extending ribs, the front end of which comes into contact with the stator cores made from a soft ferromagnetic material, at the intersection of two adjacent stator modules.

7. The electric machine of claim 6, wherein the ribs and/or the front ends have a chamfer to allow a forcible introduction of the yoke into the cylindrical outer casing.

8. The electric machine of claim 6, wherein the ribs are in contact with the lateral ends of two consecutive stator cores to ensure positioning of the stator cores constituting the yoke.

9. The electric machine of claim 1, wherein the yoke is made up of N stator modules each having a stator core made from a soft ferromagnetic material supporting a coil whose turns are arranged in planes forming an increasing angle on either side of a median transverse plane of the coil, and wherein:
the stator cores have, at their front ends, complementary assembly zones providing magnetic continuity; and
the machine further comprises a cylindrical outer casing having N longitudinal ribs, the inner front surface of which comes into contact with the outer surface of a connection zone of two adjacent stator cores to ensure the mechanical wedging of the yoke with respect to the cylindrical outer casing and thermal conduction of heat from the yoke to the cylindrical outer casing.

10. The electric machine of claim 1, wherein a stack of sheets in the axial direction and made from a non-magnetic material having a thermal conductivity higher than a thermal conductivity of air, is positioned at the interface between the cylindrical outer casing and the coil.

11. The electric machine of claim 1, further comprising a thermally conductive material at the interface between the cylindrical outer casing and the coil.

12. The electric machine of claim 10, wherein the stack of sheets is in contact with the cylindrical outer casing and the coil.

13. The electric machine of claim 11, wherein the thermally conductive material is in contact with the cylindrical outer casing and the coil.

14. The electric machine of claim 1, each coil is in the form of wound turns arranged in planes forming, with a radial plane, an increasing angle on either side of a median transverse plane of the coil, so that the radial thickness of the coil is greater inside than outside of the yoke.

15. The electric machine of claim 1, wherein:
the yoke is made up of N/2 stator modules made from a soft ferromagnetic material having two stator cores defining arms;
the two arms extending symmetrically with respect to a radial median plane;
each of the arms supporting a coil; and
the arms having, at their front ends, complementary assembly zones providing magnetic continuity.

16. The electric machine of claim 15, wherein the stator modules made from a soft ferromagnetic material have two stator cores extending on either side of a rib directed toward the side opposite the rotor and coming into contact with the inner surface of the cylindrical outer casing made from a thermally conductive material.

17. The electric machine of claim 15, wherein the cylindrical outer casing made from a thermally conductive material has radially extending ribs, the front end of which comes into contact with the stator cores made from a soft ferromagnetic material, at the intersection of two adjacent stator modules.

18. The electric machine of claim 17, wherein the ribs and/or the front ends have a chamfer to allow a forcible introduction of the yoke into the cylindrical outer casing.

19. The electric machine of claim 17, wherein the ribs are in contact with the lateral ends of two consecutive stator cores to ensure positioning of the stator cores constituting the yoke.
